(19) United States
(12) Patent Application Publication
(10) Pub. No.: US 2026/0032480 A1
(43) Pub. Date: Jan. 29, 2026

(54) METHOD AND APPARATUS FOR TRANSMITTING AND RECEIVING CHANNEL STATE INFORMATION REPORT

(71) Applicant: FUJITSU LIMITED, Kawasaki-shi (JP)

(72) Inventors: Jing ZHU, Beijing (CN); Lei ZHANG, Beijing (CN); Yiwen LU, Beijing (CN); Huiting CHENG, Yokohama (JP)

(73) Assignee: FUJITSU LIMITED, Kawasaki-shi (JP)

(21) Appl. No.: 19/349,834

(22) Filed: Oct. 3, 2025

Related U.S. Application Data
(63) Continuation of application No. PCT/CN2023/087002, filed on Apr. 7, 2023.

(51) Int. Cl. H04W 24/08; H04L 5/00; H04W 24/10

(52) U.S. Cl. CPC H04W 24/08; H04L 5/0053; H04W 24/10

(57) ABSTRACT

An apparatus for transmitting channel state information report, configured in a terminal equipment, includes: a receiver configured to receive a channel state information reporting configuration, wherein M reference signal resources being associated with the channel state information reporting configuration, the channel state information reporting configuration at least including port information and/or power information and/or codebook information of the M reference signal resources; a transmitter configured to transmit a channel state information report according to the channel state information reporting configuration; and wherein the channel state information report at least includes M pieces of channel state information, one of the M pieces of channel state information being associated with one of the M reference signal resources; wherein the port information is for antenna ports or reference signal ports, and the code book information is a codebook type parameter being expected to be set to type 1.

### CROSS-REFERENCE TO RELATED APPLICATION

This application is a continuation application under 35 U.S.C. 111 (a) of International Patent Application PCT/CN2023/087002 filed on Apr. 7, 2023, and designated the U.S., the entire contents of which are incorporated herein by reference.

### FIELD

Embodiments of the present disclosure relate to the technical field of communication.

### BACKGROUND

As an important constituent part of global new-type infrastructure construction, fifth-generation (5G) communication networks have achieved rapid development worldwide in recent years. With the construction of 5G, Active Antenna Unit (AAU) is commercially used on a large scale. Compared with Remote Radio Unit (RRU) mainly used in 3G and 4G, power consumption of the AAU is relatively large. Therefore, energy consumption of a 5G device will also increase in multiples.

5G defines three service types, i.e., Enhanced Mobile Broadband (eMBB), massive Machine Type of Communication (mMTC) and Ultra Reliable Low Latency Communication (URLLC), resulting in a continuous increase in the number of 5G small packet sudden services, with base stations working non-stop for 24 hours. Average daily energy consumption of a 5G station will also be more than twice that of a 4G station.

In addition, 3GPP introduces key technologies such as Massive MIMO and a larger radio frequency bandwidth in the 5G. 5G supports higher data rates and greater data traffic, requiring more transmission bandwidths. Deployment of a high-frequency band will also be a main frequency band for future expansion of 5G. However, high-frequency band transmission characteristics limit a coverage range of a station, thus making deployment of 5G stations more dense. Moreover, energy consumption brought about by the increase in stations will impose a huge operational cost pressure on operators.

Network scale is getting larger and larger, and the energy consumption of operators is continuously increasing. By taking the data released by the Ministry of Industry and Information Technology of China as an example, the energy consumption in 2022 will increase by about 80% compared with that in 2015. Thus, network energy saving has important significance for saving operating costs, 5G network energy saving is an urgent problem to be solved.

To achieve energy saving, a network device may carry out energy-saving processing respectively in aspects of time domain, frequency domain, spatial domain and/or energy domain, according to a network load situation. For example, in the aspects of spatial and energy domains, the network device may turn off some antennas when a load is lower, so as to achieve the purpose of energy saving. In the aspect of time domain, the network device may introduce a cell-level discontinuous transmission/reception technology, enabling the network device not to transmit and/or receive signals during certain dormant periods, so as to achieve the purpose of energy saving.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

However, the inventor finds that some scenarios of wireless communication applications (such as an energy-saving mode) might have negative impacts. For example, when a network device dynamically adjusts the number of antennas or transmission power, it may cause a change in a corresponding channel, resulting in inaccurate or untimely reporting of Channel State Information (CSI) from a terminal equipment, ultimately affecting transmission performance. How to perform CSI report by the terminal equipment is a key problem that needs to be solved currently.

For at least one of the above problems, the embodiments of the present disclosure provide a method and an apparatus for transmitting and receiving channel state information report.

According to one aspect of the embodiments of the present disclosure, a method for transmitting channel state information (CSI) report is provided, including:
a terminal equipment receives a channel state information (CSI) reporting configuration; and
transmits a CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

According to another aspect of the embodiments of the present disclosure, an apparatus for transmitting channel state information (CSI) report is provided, including:
a receiving unit, configured to receive a channel state information (CSI) reporting configuration; and
a transmitting unit, configured to transmit a CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

According to a further aspect of the embodiments of the present disclosure, a method for receiving channel state information (CSI) report is provided, including:
a network device transmits a channel state information (CSI) reporting configuration; and
the network device receives a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

According to a further aspect of the embodiments of the present disclosure, an apparatus for receiving channel state information (CSI) report is provided, including:
a transmitting unit, configured to transmit a channel state information (CSI) reporting configuration; and
a receiving unit, configured to receive a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

According to a further aspect of the embodiments of the present disclosure, a communication system is provided, including:
a network device, configured to transmit a channel state information (CSI) reporting configuration and receive a CSI report; and
a terminal equipment, configured to transmit the CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

One of advantageous effects of the embodiments of the present disclosure includes: a CSI reporting configuration is at least associated with a first reference signal resource and a second reference signal resource for channel measurement, and/or, a CSI report at least includes first channel state information (CSI) and second channel state information (CSI). Thereby, even in some scenarios (such as an energy-saving mode) of wireless communication applications, a terminal equipment is also capable of transmitting the CSI report efficiently and accurately, CSI reporting overhead can be saved and uplink resources can be saved.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in embodiments of the present disclosure;

FIG. 2 is a schematic diagram of a method for transmitting channel state information report in embodiments of the present disclosure;

FIG. 3 is a schematic diagram of a method for receiving channel state information report in embodiments of the present disclosure;

FIG. 4 is a schematic diagram of an apparatus for transmitting channel state information report in embodiments of the present disclosure;

FIG. 5 is a schematic diagram of an apparatus for receiving channel state information report in embodiments of the present disclosure;

FIG. 6 is a schematic diagram of a network device in embodiments of the present disclosure;

FIG. 7 is a schematic diagram of a terminal equipment in embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femeto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IOT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

Scenarios of the embodiments of the present disclosure are described through the following examples, however the present disclosure is not limited to these.

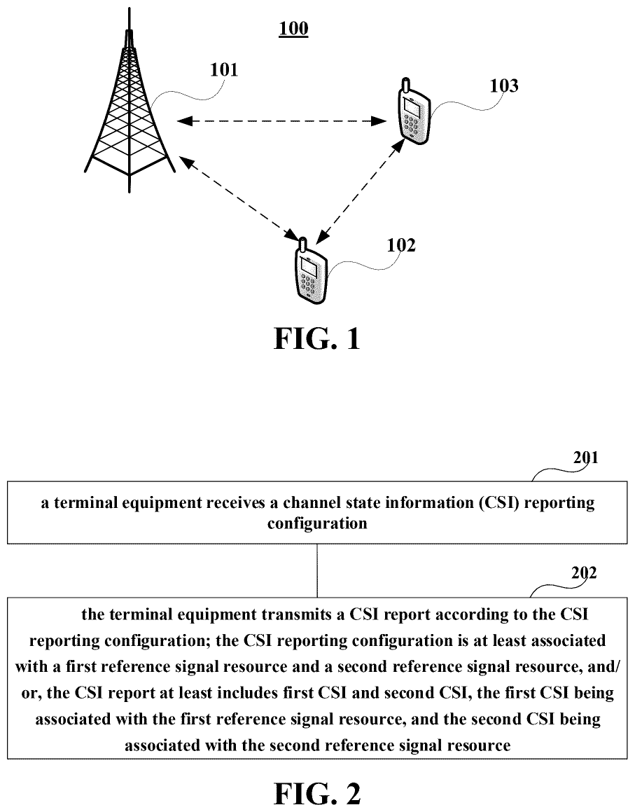

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services may be carried out between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

In the embodiments of the present disclosure, higher layer signaling may be e.g. radio resource control (RRC) signaling; for example, is called an RRC message, for example includes an MIB, system information, and a dedicated RRC message; or is called an RRC information element (RRC IE). The higher layer signaling, for example, may further be Medium Access Control (MAC) signaling; or called a MAC control element (MAC CE). However, the present disclosure is not limited to this.

In a mobile communication system, generally a terminal equipment performs Channel State Information (CSI) measurement according to indication and configuration of a network device, and then reports CSI obtained by measurement to the network device. When the network device schedules the terminal equipment, it may refer to this CSI so as to adopt an appropriate transmission mode on an appropriate resource to schedule the terminal equipment to perform transmission. Different terminal equipments may experience different physical channel conditions. Adopting a CSI feedback mechanism may rationally and effectively utilize resources, thereby improving the efficiency of entire network transmission.

In the CSI feedback mechanism of NR, the terminal equipment measures a reference signal based on a CSI configuration and performs reporting. The CSI may include a Channel Quality Indicator (CQI), a Precoding Matrix Indicator (PMI), a CSI-RS Resource Indicator (CRI), a synchronization signal/physical broadcast channel (SS/PBCH) Resource Indicator (SSBRI), a Layer Indicator (LI), or a Rank Indication (RI).

In a CSI report framework of the NR, it is carried out by associating a CSI report with a CSI resource. The CSI report may be configured as the following three types: a periodic CSI report (P-CSI): transmitted only on a Physical Uplink Control Channel (PUCCH); a semi-persistent CSI report (SP-CSI): transmitted on a PUCCH or a Physical Uplink Shared Channel (PUSCH); an aperiodic CSI report (AP-CSI): transmitted only on a PUSCH.

The following text first describes PUSCH-based CSI reporting. PUSCH-based CSI reporting supports Type I wideband or subband CSI, meanwhile also supports Type II CSI, as shown in Table 1 below.

TABLE 1

| | Frequency- | | | |
|---|---|---|---|---|
| Physical | domain | CSI | Time-domain | |
| channel | granularity | composition | characteristics | Codebook type |
| PUSCH | Wideband/ | Part1-Part2 | Semi-persistent/ | Type I/Type II |
| | subband | | aperiodic | |

For PUSCH-based Type I, Type II and enhanced Type II CSI, a CSI report consists of two parts (Part 1 and Part 2), in which CSI Part 1 (may also be called Part 1) has a fixed load size and indicates the number of information bits of CSI Part 2 (may also be called Part 2).

For Type I CSI reporting: Part 1 may include one or more of a rank indicator (RI), a CSI-RS resource indicator (CRI), a channel quality indicator (CQI) of a first codeword; Part 2 includes one or more of a precoding matrix indicator (PMI) and a CQI of a second codeword.

For Type II CSI reporting: Part 1 includes one or more of an RI, a CQI, an indication of the number of non-zero wideband amplitude coefficients per layer of Type II CSI; Part 2 includes a PMI of Type II CSI.

For enhanced Type II CSI reporting: Part 1 includes an RI, a CQI, an indication of the total number of cross-layer zero amplitude coefficients of enhanced Type II CSI; Type II includes a PMI of the enhanced Type II CSI.

When CSI reported based on a PUSCH contains Part 1 and Part 2, the terminal equipment (UE) may delete some content of Part 2. A deletion rule for Part 2 is in descending order of a priority, and the priority order is consistent with CSI field mapping order tables reported based on the PUSCH.

The following text then describes PUCCH-based CSI reporting. PUCCH-based CSI reporting supports Type I wideband or subband CSI, meanwhile also supports Type II CSI, as shown in Table 2 below.

TABLE 2

| | Frequency- | | | |
|---|---|---|---|---|
| Physical | domain | CSI | Time-domain | Codebook |
| channel | granularity | composition | characteristics | type |
| Short | Wideband | Not split | Periodic, semi- | Type I |
| PUCCH | | | persistent | |
| Long | Wideband | Not split | Periodic, semi- | Type I |
| PUCCH | | | persistent | |
| Long | Subband | Part1-Part2 | Semi- | Type I |
| PUCCH | | | persistent | |
| Long | Wideband | Part1 | Semi- | Type II |
| PUCCH | | | persistent | |

Periodic CSI reporting based on PUCCH formats 2, 3, and 4 supports wideband TypeI CSI;

Semi-persistent CSI reporting based on PUCCH format 2 supports wideband TypeI CSI;

Semi-persistent CSI reporting based on PUCCH format 3 or 4 supports wideband and subband TypeI CSI, and TypeII CSI Part 1:

for subband TypeI CSI and reporting based on PUCCH format 3 or 4, a CSI load may be divided into two parts (Part1 and Part2). Part1 includes part of all of an RI, a CRI, a CQI corresponding to a first codeword, and Part2 includes a PMI and a CQI corresponding to a second codeword.

If a CSI report contains two parts, i.e., Part1 and Part2, the terminal equipment (UE) may delete part of the content of Part2, and a priority order is consistent with CSI field mapping order tables reported based on a PUCCH.

The inventor finds that in a network energy-saving scenario, in order to alleviate a channel mutation problem caused by adjusting the number of antennas by a network device, a feasible solution is that a terminal equipment simultaneously transmits multiple CSI results, each CSI result corresponds to an antenna adjustment mode or an antenna configuration scheme, so that the network device is able to obtain CSI in a timely and accurate manner to perform data scheduling, and a solution may further be recommended for antenna adjustment of the network device.

In the network energy-saving scenario, the terminal equipment may transmit multiple pieces of CSI simultaneously, the multiple pieces of CSI may be included in the same CSI report or in different CSI reports. When a CSI reporting configuration contains multiple pieces of CSI, CSI reporting overhead may be very high, imposing a significant burden on normal transmission of the terminal equipment. Therefore, in the network energy-saving scenario, compression of the CSI reporting overhead has become an urgent problem to be solved. The following text takes an energy-saving scenario as an example for description, but the present disclosure is not limited to this, and may be applied to any scenario involving a channel state information report.

### Embodiments of a First Aspect

Embodiments of the present disclosure provide a method for transmitting channel state information report, which is described from a terminal equipment side. FIG. 2 is a schematic diagram of a method for transmitting channel state information report in the embodiments of the present disclosure. As shown in FIG. 2, the method includes:
201, a terminal equipment receives a channel state information (CSI) reporting configuration;
202, the terminal equipment transmits a CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

It should be noted that the above FIG. 2 only schematically describes the embodiments of the present disclosure, but the present disclosure is not limited to this. For example, an execution order of each operation may be adjusted appropriately, moreover other some operations may be added, or one or more operations may be removed. Persons skilled in the art may make appropriate modifications according to the above contents, not limited to the records in the above FIG. 2.

In some embodiments, the first reference signal resource is with M ports, and the second reference signal resource is with N ports, where N is less than M.

For example, the first reference signal resource is a 32-ports CSI-RS resource, and the second reference signal resource is a 16-ports CSI-RS resource; the present disclosure is not limited to this. In addition, the present disclosure takes the first reference signal resource and the second reference signal resource as examples for description, but the present disclosure is not limited to two resources or two pieces of CSI, and is also applicable to a situation of being more than two.

In some embodiments, the element includes at least one of the following: an antenna, an antenna port, a logic port, a reference signal port, an antenna factor, an antenna element, an antenna unit, reference signal transmission power, a reference signal transmission power offset, data channel transmission power, or a data channel transmission power offset.

Different modes/patterns of element adjustment correspond to different element sizes or quantities. For example, element adjustment Mode 1 corresponds to a configuration of reference signal 32-ports, and element adjustment Mode 2 corresponds to a configuration of reference signal 16-ports.

In some embodiments, the first reference signal resource and the second reference signal resource correspond to two modes/patterns for element adjustment on a channel measurement resource.

For example, the terminal equipment is configured with CSI Reporting Setting (or CSI-ReportConfig), a CSI report corresponding to the CSI Reporting Setting includes a first CSI and a second CSI, and a corresponding resource configuration for channel measurement is configured with two modes, corresponding to the first reference signal resource and the second reference signal resource respectively.

In some embodiments, the second reference signal resource with N ports is a part or a subset of the first reference signal resource with M ports, or, the second reference signal resource with N ports is different from the first reference signal resource with M ports.

In some embodiments, the channel state information (CSI) reporting configuration is per cell and/or per component carrier (per CC).

In some embodiments, the first reference signal resource or the second reference signal resource is at least one of the following: at least one channel state information resource configuration (CSI-ResourceConfig), at least one non-zero power channel state information reference signal resource set (NZP-CSI-RS-ResourceSet), or at least one non-zero power channel state information reference signal resource (NZP-CSI-RS-Resource).

For example, the second reference signal resource with N ports is a part or subset of the first reference signal resource with M ports, representing that one non-zero power channel state information reference signal resource (NZP-CSI-RS-Resource) is associated with two element adjustment modes, the first reference signal resource with M ports is the non-zero power channel state information reference signal resource (NZP-CSI-RS-Resource), the second reference signal resource with N ports is a part or subset of the non-zero power channel state information reference signal resource (NZP-CSI-RS-Resource), the part or subset may be indicated by a port index.

For another example, the second reference signal resource with N ports is different from the first reference signal resource with M ports, representing that one non-zero power channel state information reference signal resource set (NZP-CSI-RS-ResourceSet) is associated with two element adjustment modes, the non-zero power channel state information reference signal resource set (NZP-CSI-RS-ResourceSet) includes two non-zero power channel state information reference signal resources (NZP-CSI-RS-Resources) for channel measurement, the first reference signal resource with M ports corresponds to a first non-zero power channel state information reference signal resource (NZP-CSI-RS-Resource), the second reference signal resource with N ports corresponds to a second non-zero power channel state information reference signal resource (NZP-CSI-RS-Resource), wherein the number of ports of the first non-zero power channel state information reference signal resource (NZP-CSI-RS-Resource) and the number of ports of the second non-zero power channel state information reference signal resource (NZP-CSI-RS-Resource) are different.

The NR system supports multiple NZP-CSI-RS-Resources for channel measurement included in one NZP-CSI-RS-ResourceSet. The embodiments of the present disclosure are also applicable and not limited to this.

The following text first provides an exemplary description of restrictions on a CSI reporting configuration, etc.

In some embodiments, the CSI reporting configuration and/or the CSI report and/or the first channel state information (CSI) and/or the second channel state information (CSI) support(s) Type I CSI with wideband granularity.

In some embodiments, the CSI reporting configuration and/or the CSI report and/or the first channel state information (CSI) and/or the second channel state information (CSI) do/does not support Type I CSI with subband granularity, Type II CSI and enhanced Type II CSI.

For example, in the network energy-saving scenario, CSI reporting only supports reporting/feedback of Type I wideband CSI, and does not support reporting/feedback of Type I subband CSI, reporting/feedback of Type II CSI and reporting/feedback of enhanced Type II CSI.

For another example, the terminal equipment expects that both the first CSI and the second CSI are configured as Type I CSI with wideband granularity. Or, the terminal equipment expects that the second CSI is configured as Type I CSI with wideband granularity.

In some embodiments, the CSI reporting configuration and/or the CSI report and/or the first channel state information (CSI) and/or the second channel state information (CSI) support(s) Type I CSI.

In some embodiments, the CSI reporting configuration and/or the CSI report and/or the first channel state information (CSI) and/or the second channel state information (CSI) do/does not support Type II CSI and enhanced Type II CSI.

For example, in the network energy-saving scenario, CSI reporting only supports reporting/feedback of Type I CSI, including reporting/feedback of Type I wideband CSI and reporting/feedback of Type I subband CSI, and does not support reporting/feedback of Type II CSI and reporting/feedback of enhanced Type II CSI.

For another example, the terminal equipment expects that both the first CSI and the second CSI are configured as Type I CSI. Or, the terminal equipment expects that the second CSI is configured as Type I CSI.

In some embodiments, the CSI reporting configuration and/or the CSI report and/or the first channel state information (CSI) and/or the second channel state information (CSI) support(s) a CQI with wideband granularity (wideband CQI) and/or a PMI with wideband granularity (wideband PMI).

In some embodiments, the CSI reporting configuration and/or the CSI report and/or the first channel state information (CSI) and/or the second channel state information (CSI) do/does not support a CQI with subband granularity (subband CQI) and/or a PMI with subband granularity (subband PMI).

For example, the terminal equipment expects that both the first CSI and the second CSI are configured as: CQI granularity (cqi-Format Indicator) being wideband CQI and/or PMI granularity (pmi-Format Indicator) being wideband PMI.

For another example, the terminal equipment expects that the second CSI is configured as: CQI granularity (cqi-Format Indicator) being wideband CQI and/or PMI granularity (pmi-Format Indicator) being wideband PMI; the first CSI is configured as: CQI granularity (cqi-Format Indicator) being wideband CQI and/or PMI granularity (pmi-Format Indicator) being wideband PMI, or may further be configured as: CQI granularity (cqi-Format Indicator) being subband CQI and/or PMI granularity (pmi-Format Indicator) as subband PMI.

In some embodiments, the CSI reporting configuration and/or the CSI report support(s) aperiodic CSI report, or, a reporting type (reportConfigType) parameter in the CSI reporting configuration is configured as aperiodic.

The CSI reporting configuration and/or the CSI report do/does not support: PUCCH-based semi-persistent CSI report and PUSCH-based semi-persistent CSI report and periodic CSI report, or, the reporting type (reportConfigType) parameter in the CSI reporting configuration is not configured as: periodic or PUCCH semi-persistent (semiPersistentOnPUCCH) or PUSCH semi-persistent (semiPersistentOnPUSCH).

In some embodiments, the CSI reporting configuration and/or the CSI report support(s) aperiodic CSI report and PUSCH-based semi-persistent CSI report, or, the CSI reporting configuration and/or the CSI report support(s) PUSCH-based CSI report, or, a reporting type (reportConfigType) parameter in the CSI reporting configuration is configured as aperiodic or PUSCH semi-persistent (semiPersistentOnPUSCH).

The CSI reporting configuration and/or the CSI report do/does not support periodic CSI report and PUCCH-based semi-persistent CSI report, or, the CSI reporting configuration and/or the CSI report do/does not support PUCCH-based CSI report, or, a reporting type (reportConfigType) parameter in the CSI reporting configuration is not configured as periodic or PUCCH semi-persistent (semiPersistentOnPUCCH).

In some embodiments, the CSI reporting configuration and/or the CSI report support(s) aperiodic CSI report, PUSCH-based semi-persistent CSI report and PUCCH-based semi-persistent CSI report, or, the CSI reporting configuration and/or the CSI report support(s) aperiodic CSI report and semi-persistent CSI report, or, a reporting type (reportConfigType) parameter in the CSI reporting configuration is configured as aperiodic or semiPersistentOn PUSCH or semiPersistentOnPUCCH.

The CSI reporting configuration and/or the CSI report do/does not support periodic CSI report, or, a reporting type (reportConfigType) parameter in the CSI reporting configuration is not configured as periodic.

In some embodiments, a feedback quantity (reportQuantity) parameter in the channel state information (CSI) reporting configuration includes at least one of the following: first information (cri-RI-LI-PMI-CQI) indicating to feed back CRI, RI, LI, PMI and CQI, second information (cri-RI-PMI-CQI) indicating to feed back CRI, RI, PMI and CQI, third information (cri-RI-i1) indicating to feed back CRI, RI, i1, fourth information (cri-RI-i1-CQI) indicating to feed back CRI, RI, i1 and CQI, or fifth information (cri-RI-CQI) indicating to feed back CRI, RI and CQI.

For example, the terminal equipment expects that the higher-layer parameter reportQuantity is set to be at least one of the following: ‘cri-RI-LI-PMI-CQI’, ‘cri-RI-PMI-CQI’, ‘cri-RI-i1’, ‘cri-RI-i1-CQI’, or ‘cri-RI-CQI’.

The following text then describes codebook type (codebookType) configuration.

In some embodiments, a codebook type (codebookType) parameter in the channel state information (CSI) reporting configuration includes at least one of the following: type I (typeI), a type I single panel (typeI-SinglePanel), or a type I multi-panel (typeI-MultiPanel).

For example, in the network energy-saving scenario, the codebook type (codebookType) supports type1 configuration and does not support type2 configuration, that is, supports Type I-SinglePanel and/or Type I-MultiPanel and does not support Type II configuration and Type II PortSelection configuration.

In some embodiments, the channel state information (CSI) reporting configuration is associated with the first reference signal resource and the second reference signal resource, the codebook type (codebookType) is expected to be set as a first parameter, the first parameter being type I (typeI) and/or a type I single panel (typeI-SinglePanel) and/or a type I multi-panel (typeI-MultiPanel).

For example, the terminal equipment expects that the higher-layer parameter codebook Type is set to possibly include at least one of the following: ‘typeI’, ‘typeI-SinglePanel’, or ‘typeI-MultiPanel’.

The following text then schematically describes codebook configuration.

In some embodiments, a codebook configuration (codebookConfig) in the channel state information (CSI) reporting configuration is configured with a first codebook subset restriction and a second codebook subset restriction, the first codebook subset restriction being applicable to a reported PMI associated with the first reference signal resource, and the second codebook subset restriction being applicable to a reported PMI associated with the second reference signal resource.

For example, two codebook subset restrictions are configured in CodebookConfig in CSI-ReportConfig, the first codebook subset restriction applies to a reported PMI associated to a CSI-RS resource in pattern 1/mode 1, and the second codebook subset restriction applies to a reported PMI associated to a CSI-RS resource in pattern 2 or mode 2.

Or, two codebook subset restrictions are configured in CodebookConfig in CSI-ReportConfig, the first codebook subset restriction applies to a reported PMI associated to a first reference signal resource, and the second codebook subset restriction applies to a reported PMI associated to a second reference signal resource.

In some embodiments, the codebook configuration (codebookConfig) in the channel state information (CSI) reporting configuration is configured with a codebook subset restriction, the codebook subset restriction being applicable to the reported PMI associated with the first reference signal resource, and a subset of the codebook subset restriction being applicable to the reported PMI associated with the second reference signal resource.

For example, one codebook subset restriction is configured in CodebookConfig in CSI-ReportConfig, the entirety (such as all bits) of the codebook subset restriction applies to a reported PMI associated to a CSI-RS resource in pattern 1/mode 1, or applies to a reported PMI associated to the first reference signal resource, a part or subset (such as some bits) of the codebook subset restriction applies to a reported PMI associated to a CSI-RS resource in pattern 2 or mode 2, or applies to a reported PMI associated to the second reference signal resource.

In some embodiments, the codebook configuration (codebookConfig) in the channel state information (CSI) reporting configuration is configured with a first codebook subset restriction and a second codebook subset restriction, e.g. may be named a first value of a first parameter of a codebook type and a second value of the first parameter of the codebook type, wherein the first reference signal resource corresponds to the first value of the first parameter of the codebook type, and the second reference signal resource corresponds to the second value of the first parameter of the codebook type.

For example, codebook parameters of type1-SinglePanel-Pattern/Mode 1 and typeI-SinglePanel-Pattern/Mode 2 are defined. Pattern/Mode1 corresponds to the first reference signal resource, that is, corresponds to a first mode of spatial-domain/energy-domain element adjustment in the network energy-saving scenario. Pattern/Mode2 corresponds to the second reference signal resource, that is, corresponds to a second mode of spatial-domain/energy-domain element adjustment in the network energy-saving scenario. typeI-SinglePanel-Pattern/Mode 1 represents a codebook type configuration associated with the first reference signal resource, that is, a codebook type configuration of typeI-SinglePanel in the first mode of spatial-domain/energy-domain element adjustment in the network energy-saving scenario. typeI-SinglePanel-Pattern/Mode 2 represents a codebook type configuration associated with the second reference signal resource, that is, a codebook type configuration of typeI-SinglePanel in the second mode of spatial-domain/energy-domain element adjustment in the network energy-saving scenario.

For another example, codebook parameters of typeI-MultiPanel-Pattern/Mode 1 and typeI-MultiPanel-Pattern/Mode 2 are defined. Pattern/Model corresponds to the first reference signal resource, that is, corresponds to a first mode of spatial-domain/energy-domain element adjustment in the network energy-saving scenario. Pattern/Mode2 corresponds to the second reference signal resource, that is, corresponds to a second mode of spatial-domain/energy-domain element adjustment in the network energy-saving scenario. typeI-MultiPanel-Pattern/Mode 1 represents a codebook type configuration associated with the first reference signal resource, that is, a codebook type configuration of typeI-MultiPanel in the first mode of spatial-domain/energy-domain element adjustment in the network energy-saving scenario. typeI-MultiPanel-Pattern/Mode 2 represents a codebook type configuration associated with the second reference signal resource, that is, a codebook type configuration of typeI-MultiPanel in the second mode of spatial-domain/energy-domain element adjustment in the network energy-saving scenario.

The above Pattern/Mode is only a schematic explanation, words used are not limited to this. For example, it may also be called a group or set.

Table 3 exemplarily shows an example of a newly defined codebook type.

TABLE 3

| | |
|---|---|
| CodebookConfig-r18 ::= | SEQUENCE { |
| codebookType | CHOICE { |
| type1 | SEQUENCE { |
| typeI-SinglePanel-Pattern/Mode1-r18 | SEQUENCE { |
| nrOfAntennaPorts | CHOICE { |
| two | SEQUENCE { |
| twoTX-CodebookSubsetRestriction1-r18 | BIT STRING |
| (SIZE (6)) | |

In some embodiments, the channel state information (CSI) reporting configuration includes a second parameter, the second parameter being used to indicate at least one of the following:
whether the CSI report contains two or at least two pieces of CSI;
whether the CSI report is associated with two or at least two modes/patterns;
whether the CSI report is related to network energy saving;
whether the CSI report is associated with a first reference signal resource and a second reference signal resource for channel measurement.

For example, a second parameter is added in the CSI reporting configuration (CSI-ReportConfig), the second parameter being used to indicate whether current CSI reporting contains two or at least two pieces of CSI, and/or, whether the current CSI reporting is associated with two or at least two spatial/energy-domain element adjustment modes, and/or, whether the current CSI reporting is related to network energy saving, etc.

For example, the second parameter may be csi-ReportPattern, and its value may be ENUMERATED {enable, disable}, or ENUMERATED {true}, or ENUMERATED {on, off}. When the value of the second parameter is true, on or enable, it represents that the current CSI reporting contains two or at least two pieces of CSI, and/or, the current CSI reporting is associated with two or at least two spatial/energy-domain element adjustment modes, and/or, the current CSI reporting is related to network energy saving, etc.

In some embodiments, the channel state information (CSI) reporting configuration includes a second parameter, the second parameter being used to indicate at least one of the following:
the number of CSI contained in the CSI report;
modes/patterns associated with the CSI report;
the number of modes/patterns associated with the CSI report;
a CSI feedback quantity associated with the CSI report;
the number of reference signal resources for channel measurement whether is associated with the CSI report; or
port indication information of the second reference signal resource when the second parameter signal resource is a part of the first reference signal resource.

The above text schematically describes the second parameter, the present disclosure is not limited to this. The second parameter may be transmitted by the network device to the terminal equipment via any one or any combination of RRC signaling, a MAC CE or DCI. Description is made below by taking RRC signaling configuration as an example.

For example, a second parameter is added in the CSI reporting configuration (CSI-ReportConfig), the second parameter being used to indicate how many pieces of CSI are included in current CSI reporting, and/or, how many spatial/energy-domain element adjustment modes are associated with the current CSI reporting, and/or, how many pieces of CSI in the current CSI reporting are related to network energy saving, etc.

For example, the second parameter may be csi-ReportPattern, and its value may be ENUMERATED {CSImode1, CSImode2}. When the second parameter is not configured or does not appear, it represents that the current CSI reporting adopts a related art, and the CSI reporting contains one piece of CSI. When the value of the second parameter is CSImode1, it represents that the current CSI reporting contains first CSI and second CSI, associated with the first reference signal resource and the second reference signal resource, respectively corresponding to the first mode and/or the second mode of spatial-domain/energy-domain element adjustment, and/or, the current CSI reporting contains 2 pieces of CSI and a feedback quantity in each CSI. When the value of the second parameter is CSImode2, it represents that the current CSI reporting contains first, second, third and fourth CSI, associated with first, second, third and fourth reference signal resources, respectively corresponding to the first, second, third and fourth modes of spatial-domain/energy-domain element adjustment, and/or, the current CSI reporting contains 4 pieces of CSI and a feedback quantity in each CSI.

The following text then schematically describes a CSI feedback quantity. For example, the second parameter is included in the CSI reporting configuration (CSI-ReportConfig), when a higher-layer parameter is set to enable, on, true, or CSImode1 or CSImode2, multiple pieces of CSI are included in the CSI report.

In some embodiments, based on the second parameter, or based on the first reference signal resource and the second reference signal resource, the terminal equipment transmits a first CRI and a second CRI, or transmits the first CRI and does not transmit the second CRI, or transmits neither the first CRI nor the second CRI; the first CRI and the second CRI are associated with the first reference signal resource and the second reference signal resource, respectively, or are associated with the first CSI and the second CSI, respectively.

For example, the terminal equipment reports: all feedback quantities of the first CSI+all feedback quantities of the second CSI, such as CRI1, CRI2, RI1, RI2, CQI1, CQI2, PMI1, PMI2, LI1, LI2; wherein the first CSI contains CRI1, RI1, CQI1, PMI1 and LI1, and the second CSI contains CRI2, RI2, CQI2, PMI2 and LI2.

Or, the terminal equipment reports: two CRIs, two RIs, two PMIs, two CQIs and two LIs (if configured), associated with the first reference signal resource and the second reference signal resource, respectively. The first reference signal resource corresponds to the first CSI, and the second reference signal resource corresponds to the second CSI.

For another example, the terminal equipment reports all feedback quantities of the first CSI+part of feedback quantities of the second CSI. The CRI is omitted in the second CSI, representing that the CRI of the second CSI is the same as that of the first CSI, may be omitted and is not reported. The terminal equipment reports: CRI1, RI1, RI2, CQI1, CQI2, PMI1, PMI2, LI1 and LI2, wherein the first CSI contains CRI1, RI1, CQI1, PMI1 and LI1, and the second CSI contains RI2, CQI2, PMI2 and LI2.

Or, the terminal equipment reports: one CRI, two RIs, two PMIs, two CQIs and two LIs (if configured), the CRI is associated with the first reference signal resource, two RIs, two PMIs, two CQIs and two LIs are associated with the first reference signal resource and the second reference signal resource, respectively. The first reference signal resource corresponds to the first CSI, and the second reference signal resource corresponds to the second CSI.

For another example, the terminal equipment reports part of feedback quantities of the first CSI+part of feedback quantities of the second CSI. The CRI is omitted in both the first CSI and the second CSI, representing that the terminal equipment does not need to report the CRI. The terminal equipment reports: RI1, RI2, CQI1, CQI2, PMI1, PMI2, LI1 and LI2, wherein the first CSI contains RI1, CQI1, PMI1 and LI1, and the second CSI contains RI2, CQI2, PMI2 and LI2.

Or, the terminal equipment reports: two RIs, two PMIs, two CQIs and two LIs (if configured), two RIs, two PMIs, two CQIs and two LIs are associated with the first reference signal resource and the second reference signal resource, respectively. The first reference signal resource corresponds to the first CSI, and the second reference signal resource corresponds to the second CSI.

In some embodiments, based on the second parameter, or based on the first reference signal resource and the second reference signal resource, the terminal equipment transmits a first RI and a second RI, or transmits the first RI; the first RI and the second RI are associated with the first reference signal resource and the second reference signal resource, respectively, or are associated with the first CSI and the second CSI, respectively.

For example, the terminal equipment reports all feedback quantities of the first CSI+part of feedback quantities of the second CSI. A value of a RI of the first CSI is the same as a value of a RI of the second CSI, the terminal equipment only needs to report the RI of the first CSI, the RI of the second CSI may be omitted and is not reported, the network device knows that the RI of the second CSI is the same as the RI of the first CSI. The terminal equipment reports: CRI1, CRI2, RI1, CQI1, CQI2, PMI1, PMI2, LI1 and LI2, wherein the first CSI contains CRI1, RI1, CQI1, PMI1 and LI1, and the second CSI contains CRI2, CQI2, PMI2 and LI2.

Or, the terminal equipment reports: two CRIs, one RI, two PMIs, two CQIs and two LIs (if configured), the RI is associated with the first reference signal resource, two CRIs, two PMIs, two CQIs and two LIs are associated with the first reference signal resource and the second reference signal resource, respectively. The first reference signal resource corresponds to the first CSI, and the second reference signal resource corresponds to the second CSI.

In some embodiments, based on the second parameter, or based on the first reference signal resource and the second reference signal resource, the terminal equipment transmits a first PMI and a second PMI, or transmits the first PMI; a network device derives the second PMI based on the first PMI; the first PMI and the second PMI are associated with the first reference signal resource and the second reference signal resource, respectively, or are associated with the first CSI and the second CSI, respectively.

For example, the terminal equipment reports all feedback quantities of the first CSI+part of feedback quantities of the second CSI. The PMI is omitted in the second CSI, representing that the PMI of the second CSI may be derived from the PMI of the first CSI, and may be omitted and is not reported. The terminal equipment reports: CRI1, CRI2, RI1, RI2, CQI1, CQI2, PMI1, LI1 and LI2, wherein the first CSI contains CRI1, RI1, CQI1, PMI1 and LI1, and the second CSI contains CRI2, RI2, CQI2 and LI2.

Or, the terminal equipment reports: two CRIs, two RIs, one PMI, two CQIs and two LIs (if configured), the PMI is associated with the first reference signal resource, two RIs, two CRIs, two CQIs and two LIs are associated with the first reference signal resource and the second reference signal resource, respectively. The first reference signal resource corresponds to the first CSI, and the second reference signal resource corresponds to the second CSI.

In some embodiments, based on the second parameter, or based on the first reference signal resource and the second reference signal resource, the terminal equipment transmits a first PMI and a first PMI offset; the network device derives the second PMI based on the first PMI and the first PMI offset; the first PMI and the first PMI offset are associated with the first reference signal resource and the second reference signal resource, respectively, or are associated with the first CSI and the second CSI, respectively.

For example, the PMI2 of the second CSI is the offset of the PMI 1 of the first CSI. The terminal equipment reports PMI1 and PMI offsets of the first CSI. Based on these two parameters, the network device may infer the PMI of the second CSI to save reported bits. The terminal equipment reports: CRI1, CRI2, RI1, RI2, CQI1, CQI2, PMI1, PMI1_offset, LI1 and LI2, wherein the first CSI contains CRI1, RI1, CQI1, PMI1 and LI1, and the second CSI contains CRI2, RI2, CQI2, PMI1_offset and LI2.

Or, the terminal equipment reports: two CRIs, two RIs, one PMI, one PMI offset, two CQIs and two LIs (if configured), the PMI offset is associated with the second reference signal resource, two RIs, two CRIs, two CQIs and two LIs are associated with the first reference signal resource and the second reference signal resource, respectively. The first reference signal resource corresponds to the first CSI, and the second reference signal resource corresponds to the second CSI.

In some embodiments, based on the second parameter, or based on the first reference signal resource and the second reference signal resource, the terminal equipment transmits a first CQI and a second CQI, or transmits the first CQI; a network device derives the second CQI based on the first CQI; the first CQI and the second CQI are associated with the first reference signal resource and the second reference signal resource, respectively, or are associated with the first CSI and the second CSI, respectively.

For example, the terminal equipment reports all feedback quantities of the first CSI+part of feedback quantities of the second CSI. The CQI is omitted in the second CSI, representing that the CQI of the second CSI may be derived from the CQI of the first CSI, and may be omitted and is not reported. The terminal equipment reports: CRI1, CRI2, RI1, RI2, CQI1, PMI1, PMI2, LI1 and LI2, wherein the first CSI contains CRI1, RI1, CQI1, PMI1 and LI1, and the second CSI contains CRI2, RI2, PMI2 and LI2.

Or, the terminal equipment reports: two CRIs, two RIs, two PMIs, one CQI and two LIs (if configured), the CQI is associated with the first reference signal resource, two RIs, two CRIs, two PMIs and two LIs are associated with the first reference signal resource and the second reference signal resource, respectively. The first reference signal resource corresponds to the first CSI, and the second reference signal resource corresponds to the second CSI.

In some embodiments, based on the second parameter, or based on the first reference signal resource and the second reference signal resource, the terminal equipment transmits a first CQI and a first CQI offset; the network device derives the second CQI based on the first CQI and the first CQI offset; the first CQI and the first CQI offset are associated with the first reference signal resource and the second reference signal resource, respectively, or are associated with the first CSI and the second CSI, respectively.

For example, the CQI2 of the second CSI is the offset of the CQI 1 of the first CSI. For example, the wideband CQI1 of the first CSI is 4 bits, the wideband CQI2 of the second CSI only reports a 2-bit offset, that is, offset relative to CQI1, so as to save reported bits; the network device may derive the CQI2 of the second CSI based on the CQI1 and CQI1_offset of the first CSI. The terminal equipment reports: CRI1, CRI2, RI1, RI2, CQI1, CQI1_offset, PMI1, PMI2, LI1 and LI2, wherein the first CSI contains CRI1, RI1, CQI1, PMI1 and LI1, and the second CSI contains CRI2, RI2, CQI1_offset, PMI2 and LI2.

Or, the terminal equipment reports: two CRIs, two RIs, two PMIs, one CQI, one CQI offset and two LIs (if configured), the CQI offset is associated with the second reference signal resource, two RIs, two CRIs, two PMIs and two LIs are associated with the first reference signal resource and the second reference signal resource, respectively. The first reference signal resource corresponds to the first CSI, and the second reference signal resource corresponds to the second CSI.

In some embodiments, in a case where LI is configured, based on the second parameter, or based on the first reference signal resource and the second reference signal resource, the terminal equipment transmits a first L1 and a second LI, or transmits the first L1 and does not transmit the second L1, or transmits neither the first LI nor the second LI.

The above text exemplarily describes some situations of reporting the CSI, the present disclosure is not limited to this. The above modes may be implemented separately or jointly.

For example, the first CSI contains CRI1, RI1, PMI1, CQI1 and LI1, the second CSI contains RI2, PMI1_offset and CQI1_offset; thus, the CSI report contains CRI1, RI1, RI2, PMI1, PMI1_offset, CQI1, CQI1_offset and LI1.

For another example, the first CSI contains CRI1, RI1, PMI1, CQI1 and LI1, the second CSI contains RI2, PMI1_offset and CQI2; thus, the CSI report contains CRI1, RI1, RI2, PMI1, PMI1_offset, CQI1, CQI2 and LI1, and so on.

Description is made above by taking the first CSI and the second CSI as examples, the present disclosure is not limited to this, the CSI report may include more than two pieces of CSI, the following text then schematically describes situations of N pieces of CSI.

In some embodiments, the CSI report includes N pieces of CSI, the CSI reporting configuration is at least associated with N reference signal resources for channel measurement, the N pieces of CSI are associated with the N reference signal resources respectively, where N is greater than or equal to 2.

In some embodiments, the terminal equipment selects/decides/determines that the CSI report contains K pieces of CSI, the K pieces of CSI at least including the first CSI and the second CSI, where K is greater than or equal to 2 and K is less than or equal to N. The first CSI in the K pieces of CSI and a third parameter are contained in a first part (CSI Part I) of the CSI report, and the remaining (K−1) pieces of CSI are contained in the second part (CSI Part II) of the CSI report.

The third parameter is used to indicate a feedback quantity and/or bit size of the (K−1) pieces of CSI in the second part (CSI Part II). For example, the third parameter indicates whether the (K−1) pieces of CSI in the CSI Part II contain the CRI and/or the RI and/or the PMI and/or the PMI offset and/or the CQI and/or the CQI offset.

For example, the terminal equipment transmits the first CSI and the second CSI, the first CSI contains all CRIs, RIs, PMIs and CQIs, which are contained in CSI Part I; the second CSI is contained in Part II, whether the second CSI includes a PMI or an RI is determined by the third parameter.

Unlike the previous embodiments which stipulate whether the RI or PMI is transmitted in the second CSI, etc., here the terminal equipment determines whether to transmit a part of it (such as RI or PMI or CQI, etc.) and indicates via the third parameter. Thereby, flexibility can be further enhanced.

In some embodiments, the CSI reporting configuration is at least associated with N reference signal resources for channel measurement, and/or, the CSI report includes N pieces of channel state information (CSI), the N pieces of CSI being associated with the N reference signal resources respectively.

In some embodiments, the terminal equipment selects/decides/determines that the CSI report contains K pieces of CSI, where K is greater than or equal to 1 and K is less than or equal to N. The first CSI in the K pieces of CSI and a third parameter are contained in a first part (CSI Part I) of the CSI report, and the remaining (K−1) pieces of CSI are contained in the second part (CSI Part II) of the CSI report.

The third parameter is used to indicate a feedback quantity and/or bit size of the (K−1) pieces of CSI in the second part (CSI Part II). For example, the third parameter indicates whether the (K−1) pieces of CSI in the CSI Part II contain the CRI and/or the RI and/or the PMI and/or the PMI offset and/or the CQI and/or the CQI offset.

Each of the above embodiments is only illustrative for the present disclosure, but the present disclosure is not limited to this, appropriate modifications may be further made based on the above each embodiment. For example, each of the above embodiments may be used individually, or one or more of the above embodiments may be combined.

As may be known from the above embodiments, even in some scenarios (such as an energy-saving mode) of wireless communication applications, a terminal equipment is also capable of transmitting the CSI report efficiently and accurately, CSI reporting overhead can be saved and uplink resources can be saved.

### Embodiments of a Second Aspect

Embodiments of the present disclosure provide a method for receiving channel state information report, which is described from a network device side. Embodiments of the second aspect may be combined with the embodiments of the first aspect, the same contents as the embodiments of the first aspect are not repeated.

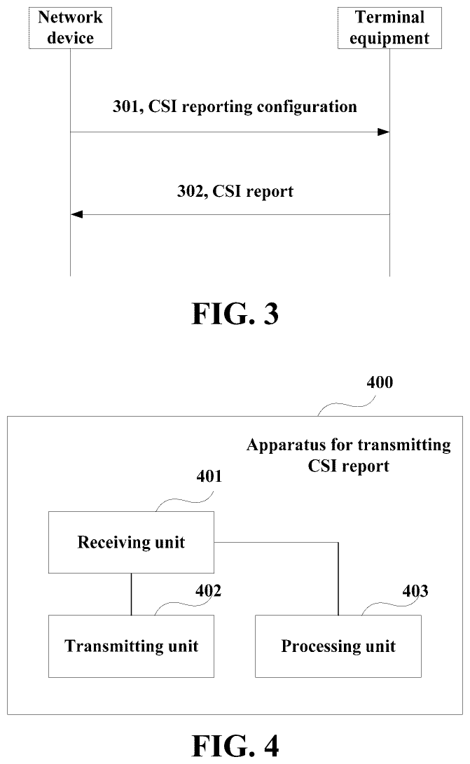

FIG. 3 is a schematic diagram of a method for receiving channel state information report in the embodiments of the present disclosure. As shown in FIG. 3, the method includes:
301, a network device transmits a channel state information (CSI) reporting configuration; and
302, the network device receives a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

It should be noted that the above FIG. 3 only schematically describes the embodiments of the present disclosure, but the present disclosure is not limited to this. For example, an execution order of each operation may be adjusted appropriately, moreover other some operations may be added, or one or more operations may be removed. Persons skilled in the art may make appropriate modifications according to the above contents, not limited to the records in the above FIG. 3.

Each of the above embodiments is only illustrative for the present disclosure, but the present disclosure is not limited to this, appropriate modifications may be further made based on the above each embodiment. For example, each of the above embodiments may be used individually, or one or more of the above embodiments may be combined.

As may be known from the above embodiments, even in some scenarios (such as an energy-saving mode) of wireless communication applications, a terminal equipment is also capable of transmitting the CSI report efficiently and accurately, CSI reporting overhead can be saved and uplink resources can be saved.

### Embodiments of a Third Aspect

Embodiments of the present disclosure provide an apparatus for transmitting channel state information report. The apparatus for example may be a terminal equipment, or may be one or more parts or components configured in the terminal equipment, contents same as the embodiments of the first aspect are not repeated.

FIG. 4 is a schematic diagram of an apparatus for transmitting channel state information report in the embodiments of the present disclosure. As shown in FIG. 4, the apparatus 400 for transmitting channel state information report includes:
a receiving unit 401, configured to receive a channel state information (CSI) reporting configuration; and
a transmitting unit 402, configured to transmit a CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

In some embodiments, the first reference signal resource is with M ports, and the second reference signal resource is with N ports, where N is less than M.

In some embodiments, the second reference signal resource with N port is a part of the first reference signal resource with M ports, or, the second reference signal resource with N ports is different from the first reference signal resource with M ports.

In some embodiments, the channel state information (CSI) reporting configuration is per cell and/or per component carrier (per CC).

In some embodiments, the element includes at least one of the following: an antenna, an antenna port, a logic port, a reference signal port, an antenna factor, an antenna element, an antenna unit, reference signal transmission power, a reference signal transmission power offset, data channel transmission power, a data channel transmission power offset.

In some embodiments, the first reference signal resource or the second reference signal resource includes at least one of the following: at least one channel state information resource configuration (CSI-ResourceConfig), at least one non-zero power channel state information reference signal resource set (NZP-CSI-RS-ResourceSet), or at least one non-zero power channel state information reference signal resource (NZP-CSI-RS-Resource).

In some embodiments, the CSI report and/or the first channel state information (CSI) and/or the second channel state information (CSI) support(s) Type I CSI with wideband granularity.

In some embodiments, the CSI report and/or the first channel state information (CSI) and/or the second channel state information (CSI) do/does not support Type I CSI with subband granularity, Type II CSI and enhanced Type II CSI.

In some embodiments, the CSI report and/or the first channel state information (CSI) and/or the second channel state information (CSI) support(s) Type I CSI.

In some embodiments, the CSI report and/or the first channel state information (CSI) and/or the second channel state information (CSI) do/does not support Type II CSI and enhanced Type II CSI.

In some embodiments, the CSI report and/or the first channel state information (CSI) and/or the second channel state information (CSI) support(s) a CQI with wideband granularity (wideband CQI) and/or a PMI with wideband granularity (wideband PMI).

In some embodiments, the CSI report and/or the first channel state information (CSI) and/or the second channel state information (CSI) do/does not support a CQI with subband granularity (subband CQI) and/or a PMI with subband granularity (subband PMI).

In some embodiments, the CSI report supports aperiodic CSI report, or, a reporting type (reportConfigType) parameter in the CSI reporting configuration is configured as aperiodic.

In some embodiments, the CSI report does not support: PUCCH-based semi-persistent CSI report and PUSCH-based semi-persistent CSI report and periodic CSI report, or, the reporting type (reportConfigType) parameter in the CSI reporting configuration is not configured as: periodic or PUCCH semi-persistent (semiPersistentOnPUCCH) or PUSCH semi-persistent (semiPersistentOnPUSCH).

In some embodiments, the CSI report supports aperiodic CSI report and PUSCH-based semi-persistent CSI report, or, the CSI report supports PUSCH-based CSI report, or, a reporting type (reportConfigType) parameter in the CSI reporting configuration is configured as aperiodic or PUSCH semi-persistent (semiPersistentOnPUSCH).

In some embodiments, the CSI report does not support periodic CSI report and PUCCH-based semi-persistent CSI report, or, the CSI report does not support PUCCH-based CSI report, or, a reporting type (reportConfigType) parameter in the CSI reporting configuration is not configured as periodic or PUCCH semi-persistent (semiPersistentOnPUCCH).

In some embodiments, the CSI report supports aperiodic CSI report, PUSCH-based semi-persistent CSI report and PUCCH-based semi-persistent CSI report, or, the CSI report supports aperiodic CSI report and semi-persistent CSI report, or, a reporting type (reportConfigType) parameter in the CSI reporting configuration is configured as aperiodic or semiPersistentOnPUSCH or semiPersistentOnPUCCH.

In some embodiments, the CSI report does not support periodic CSI report, or, a reporting type (reportConfigType) parameter in the CSI reporting configuration is not configured as periodic.

In some embodiments, a feedback quantity (reportQuantity) parameter in the channel state information (CSI) reporting configuration includes at least one of the following: first information (cri-RI-LI-PMI-CQI) indicating to feed back CRI, RI, LI, PMI and CQI, second information (cri-RI-PMI-CQI) indicating to feed back CRI, RI, PMI and CQI, third information (cri-RI-i1) indicating to feed back CRI, RI, i1, fourth information (cri-RI-i1-CQI) indicating to feed back CRI, RI, i1 and CQI, or fifth information (cri-RI-CQI) indicating to feed back CRI, RI and CQI.

In some embodiments, a codebook type (codebookType) parameter in the channel state information (CSI) reporting configuration includes at least one of the following: a type I single panel (typeI-SinglePanel), or a type I multi-panel (typeI-MultiPanel).

In some embodiments, the channel state information (CSI) reporting configuration is associated with the first reference signal resource and the second reference signal resource, the codebook type (codebookType) is expected to be set as a first parameter, the first parameter being type I (type1) and/or a type I single panel (typeI-SinglePanel) and/or a type I multi-panel (typeI-MultiPanel).

In some embodiments, a codebook configuration (codebookConfig) in the channel state information (CSI) reporting configuration is configured with a first codebook subset restriction and a second codebook subset restriction, the first codebook subset restriction being applicable to a reported PMI associated with the first reference signal resource, and the second codebook subset restriction being applicable to a reported PMI associated with the second reference signal resource.

In some embodiments, the codebook configuration (codebookConfig) in the channel state information (CSI) reporting configuration is configured with a codebook subset restriction, the codebook subset restriction being applicable to the reported PMI associated with the first reference signal resource, and a subset of the codebook subset restriction being applicable to the reported PMI associated with the second reference signal resource.

In some embodiments, the codebook configuration (codebookConfig) in the channel state information (CSI) reporting configuration is configured with a first codebook subset restriction and a second codebook subset restriction, wherein the first reference signal resource corresponds to a first value of the first parameter of the codebook type, and the second reference signal resource corresponds to a second value of the first parameter of the codebook type.

In some embodiments, the channel state information (CSI) reporting configuration includes a second parameter, the second parameter being used to indicate at least one of the following:
whether the CSI report contains multiple pieces of CSI;
whether the CSI report is associated with multiple modes/patterns;
whether the CSI report is related to network energy saving; or
whether the CSI report is associated with a first reference signal resource and a second reference signal resource for channel measurement.

In some embodiments, the channel state information (CSI) reporting configuration includes a second parameter, the second parameter being used to indicate at least one of the following:
the number of CSI contained in the CSI report;
modes/patterns associated with the CSI report;
the number of modes/patterns associated with the CSI report;
a CSI feedback quantity associated with the CSI report;
the number of reference signal resources for channel measurement whether is associated with the CSI report; or
port indication information of the second reference signal resource when the second parameter signal resource is a part of the first reference signal resource.

In some embodiments, based on the second parameter, or based on the first reference signal resource and the second reference signal resource, the terminal equipment transmits a first CRI and a second CRI, or transmits the first CRI and does not transmit the second CRI, or transmits neither the first CRI nor the second CRI;
the first CRI and the second CRI are associated with the first reference signal resource and the second reference signal resource, respectively, or are associated with the first CSI and the second CSI, respectively.

In some embodiments, based on the second parameter, or based on the first reference signal resource and the second reference signal resource, the terminal equipment transmits a first RI and a second RI, or transmits the first RI;
the first RI and the second RI are associated with the first reference signal resource and the second reference signal resource, respectively, or are associated with the first CSI and the second CSI, respectively.

In some embodiments, based on the second parameter, or based on the first reference signal resource and the second reference signal resource, the terminal equipment transmits a first PMI and a second PMI, or transmits the first PMI;
a network device derives the second PMI based on the first PMI; the first PMI and the second PMI are associated with the first reference signal resource and the second reference signal resource, respectively, or are associated with the first CSI and the second CSI, respectively.

In some embodiments, based on the second parameter, or based on the first reference signal resource and the second reference signal resource, the terminal equipment transmits a first PMI and a first PMI offset;
the network device derives the second PMI based on the first PMI and the first PMI offset; the first PMI and the first PMI offset are associated with the first reference signal resource and the second reference signal resource, respectively, or are associated with the first CSI and the second CSI, respectively.

In some embodiments, based on the second parameter, or based on the first reference signal resource and the second reference signal resource, the terminal equipment transmits a first CQI and a second CQI, or transmits the first CQI;
the network device derives the second CQI based on the first CQI; the first CQI and the second CQI are associated with the first reference signal resource and the second reference signal resource, respectively, or are associated with the first CSI and the second CSI, respectively.

In some embodiments, based on the second parameter, or based on the first reference signal resource and the second reference signal resource, the terminal equipment transmits a first CQI and a first CQI offset;
the network device derives the second CQI based on the first CQI and the first CQI offset; the first CQI and the first CQI offset are associated with the first reference signal resource and the second reference signal resource, respectively, or are associated with the first CSI and the second CSI, respectively.

In some embodiments, in a case where LI is configured, based on the second parameter, or based on the first reference signal resource and the second reference signal resource, the terminal equipment transmits a first L1 and a second LI, or transmits the first L1 and does not transmit the second L1, or transmits neither the first LI nor the second LI.

In some embodiments, the CSI report includes N pieces of CSI, the CSI reporting configuration is at least associated with N reference signal resources for channel measurement, the N pieces of CSI are associated with the N reference signal resources respectively, where N is greater than or equal to 2.

In some embodiments, as shown in FIG. 4, the apparatus 400 for transmitting channel state information report may further include:
a processing unit 403, configured to select/decide/determine that the CSI report contains K pieces of CSI, the K pieces of CSI at least including the first CSI and the second CSI, where K is greater than or equal to 2 and K is less than or equal to N.

In some embodiments, the first CSI in the K pieces of CSI, and a third parameter are included in a first part (CSI Part I) in the CSI report, the remaining (K−1) pieces of CSI are included in a second part (CSI Part II) in the CSI report, and the third parameter is used to indicate a feedback quantity of and/or a bit size of the (K−1) pieces of CSI in the second part (CSI Part II).

In some embodiments, the third parameter indicates whether the (K−1) pieces of CSI in the second part (CSI Part II) contain the CRI and/or the RI and/or the PMI and/or the PMI offset and/or the CQI and/or the CQI offset.

In some embodiments, a terminal equipment receives a channel state information (CSI) reporting configuration; and transmits a CSI report according to the channel state information (CSI) reporting configuration; wherein the CSI reporting configuration is at least associated with N reference signal resources for channel measurement, and/or, the CSI report includes N pieces of channel state information (CSI), the N pieces of CSI being associated with the N reference signal resources respectively.

In some embodiments, the terminal equipment selects/decides/determines that the CSI report contains K pieces of CSI, where K is greater than or equal to 1 and K is less than or equal to N.

In some embodiments, the first CSI in the K pieces of CSI, and a third parameter are included in a first part (CSI Part I) in the CSI report, the remaining (K−1) pieces of CSI are included in a second part (CSI Part II) in the CSI report, and the third parameter is used to indicate a feedback quantity of and/or a bit size of the (K−1) pieces of CSI in the second part (CSI Part II).

In some embodiments, the third parameter indicates whether the (K−1) pieces of CSI in the second part (CSI Part II) contain the CRI and/or the RI and/or the PMI and/or the PMI offset and/or the CQI and/or the CQI offset.

It's worth noting that the above only describes components or modules related to the present disclosure, but the present disclosure is not limited to this. The apparatus 400 for transmitting channel state information report may further include other components or modules. For detailed contents of these components or modules, relevant technologies may be referred to.

Moreover, for the sake of simplicity, FIG. 4 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Through the embodiments of the present disclosure, even in some scenarios (such as an energy-saving mode) of wireless communication applications, a terminal equipment is also capable of transmitting the CSI report efficiently and accurately, CSI reporting overhead can be saved and uplink resources can be saved.

### Embodiments of a Fourth Aspect

Embodiments of the present disclosure provide an apparatus for receiving channel state information report. The apparatus may be a network device, or may be one or more parts or components configured in the network device. The contents same as the embodiments of the first and second aspect are not repeated.

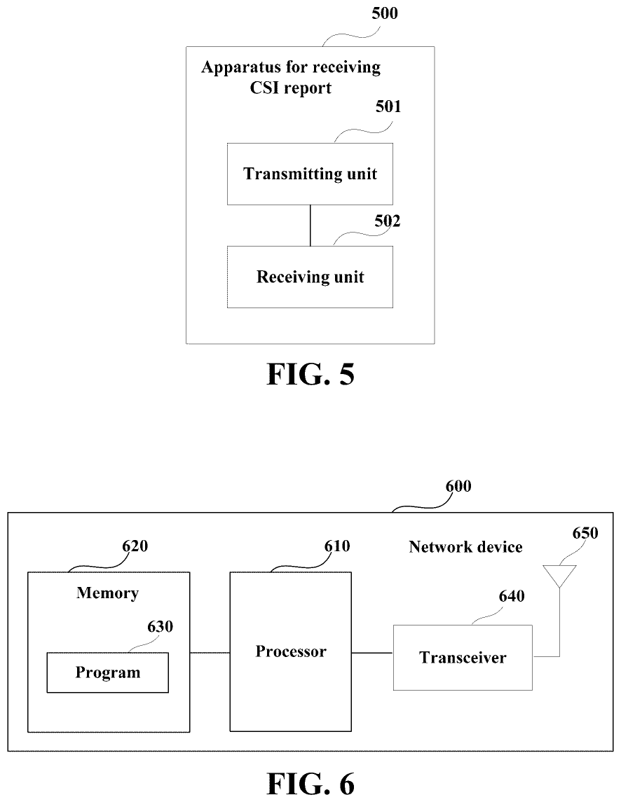

FIG. 5 is a schematic diagram of an apparatus for receiving channel state information report in the embodiments of the present disclosure. As shown in FIG. 5, the apparatus 500 for receiving channel state information report includes:
a transmitting unit 501, configured to transmit a channel state information (CSI) reporting configuration; and
a receiving unit 502, configured to receive a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

It's worth noting that the above only describes components or modules related to the present disclosure, but the present disclosure is not limited to this. The apparatus 500 for receiving channel state information report may further include other components or modules. For detailed contents of these components or modules, relevant technologies may be referred to.

Moreover, for the sake of simplicity, FIG. 5 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Through the embodiments of the present disclosure, even in some scenarios (such as an energy-saving mode) of wireless communication applications, a terminal equipment is also capable of transmitting the CSI report efficiently and accurately, CSI reporting overhead can be saved and uplink resources can be saved.

### Embodiments of a Fifth Aspect

Embodiments of the present disclosure further provide a communication system, FIG. 1 may be referred to, the contents same as the embodiments of the first to fourth aspects are not repeated.

In some embodiments, a communication system 100 at least may include:
a network device transmits a channel state information (CSI) reporting configuration; and
the network device receives a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

Embodiments of the present disclosure further provide a network device, for example may be a base station, but the present disclosure is not limited to this, it may also be other network device.

FIG. 6 is a composition schematic diagram of a network device in the embodiments of the present disclosure. As shown in FIG. 6, the network device 600 may include: a processor 610 (such as a central processing unit (CPU)) and a memory 620; the memory 620 is coupled to the processor 610. The memory 620 may store various data; moreover, also stores a program 630 for information processing, and executes the program 630 under the control of the processor 610.

For example, the processor 610 may be configured to execute a program to implement the method for receiving channel state information report as described in the embodiments of the second aspect. For example, the processor 610 may be configured to perform the following control: transmitting a channel state information (CSI) reporting configuration; and receiving a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

In addition, as shown in FIG. 6, the network device 600 may further include: a transceiver 640 and an antenna 650, etc.; wherein the functions of said components are similar to relevant arts, which are not repeated here. It's worth noting that the network device 600 does not have to include all the components shown in FIG. 6. Moreover, the network device 600 may further include components not shown in FIG. 6, relevant arts may be referred to.

Embodiments of the present disclosure further provide a terminal equipment, but the present disclosure is not limited to this, it may also be other device.

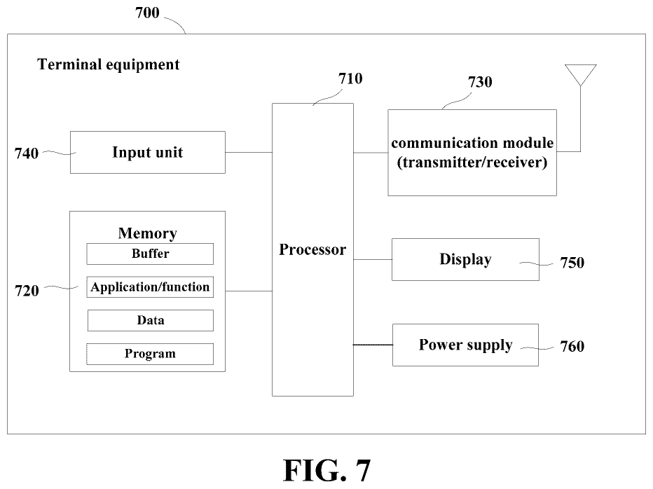

FIG. 7 is a schematic diagram of a terminal equipment in the embodiments of the present disclosure. As shown in FIG. 7, the terminal equipment 700 may include a processor 710 and a memory 720; the memory 720 stores data and programs, and is coupled to the processor 710. It's worth noting that this figure is exemplary; other types of structures can also be used to supplement or replace this structure, so as to realize a telecommunication function or other functions.

For example, the processor 710 may be configured to execute a program to implement the method for transmitting channel state information report as described in the embodiments of the first aspect. For example, the processor 710 may be configured to perform the following control: receiving a channel state information (CSI) reporting configuration; and transmitting a CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

As shown in FIG. 7, the terminal equipment 700 may further include: a communication module 730, an input unit 740, a display 750 and a power supply 760. The functions of said components are similar to relevant arts, which are not repeated here. It's worth noting that the terminal equipment 700 does not have to include all the components shown in FIG. 7, said components are not indispensable. Moreover, the terminal equipment 700 may further include components not shown in FIG. 7, relevant arts may be referred to.

Embodiments of the present disclosure further provide a computer program, wherein when a terminal equipment executes the program, the program enables the terminal equipment to execute the method for transmitting channel state information report described in the embodiments of the first aspect.

Embodiments of the present disclosure further provide a storage medium in which a computer program is stored, wherein the computer program enables a terminal equipment to execute the method for transmitting channel state information report described in the embodiments of the first aspect.

Embodiments of the present disclosure further provide a computer program, wherein when a network device executes the program, the program enables the network device to execute the method for receiving channel state information report described in the embodiments of the second aspect.

Embodiments of the present disclosure further provide a storage medium in which a computer program is stored, wherein the computer program enables a network device to execute the method for receiving channel state information report described in the embodiments of the second aspect. The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

As for the implementations including the above embodiments, the following supplements are further disclosed:

1. A method for transmitting channel state information (CSI) report, including:
a terminal equipment receives a channel state information (CSI) reporting configuration; and
transmits a CSI report according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

2. The method according to Supplement 1, wherein the first reference signal resource is with M ports, and the second reference signal resource is with N ports, where N is less than M.

3. The method according to Supplement 2, wherein the second reference signal resource with N ports is a part of the first reference signal resource with M ports, or, the second reference signal resource with N ports is different from the first reference signal resource with M ports.

4. The method according to Supplement 1, wherein the channel state information (CSI) report configuration is per cell and/or per component carrier (per CC).

5. The method according to Supplement 1, wherein the first reference signal resource and the second reference signal resource correspond to two modes/patterns for element adjustment on a channel measurement resource;
the element includes at least one of the following: an antenna, an antenna port, a logic port, a reference signal port, an antenna factor, an antenna element, an antenna unit, reference signal transmission power, a reference signal transmission power offset, data channel transmission power, or a data channel transmission power offset.

6. The method according to any one of Supplements 1 to 5, wherein the first reference signal resource or the second reference signal resource includes at least one of the following: at least one channel state information resource configuration (CSI-ResourceConfig), at least one non-zero power channel state information reference signal resource set (NZP-CSI-RS-ResourceSet), or at least one non-zero power channel state information reference signal resource (NZP-CSI-RS-Resource).

7. The method according to any one of Supplements 1 to 6, wherein the CSI report and/or the first channel state information (CSI) and/or the second channel state information (CSI) support(s) Type I CSI with wideband granularity.

8. The method according to Supplement 7, wherein the CSI reporting configuration and/or the CSI report and/or the first channel state information (CSI) and/or the second channel state information (CSI) do/does not support Type I CSI with subband granularity, Type II CSI and enhanced Type II CSI.

9. The method according to any one of Supplements 1 to 6, wherein the CSI reporting configuration and/or the CSI report and/or the first channel state information (CSI) and/or the second channel state information (CSI) support(s) Type I CSI.

10. The method according to Supplement 9, wherein the CSI reporting configuration and/or the CSI report and/or the first channel state information (CSI) and/or the second channel state information (CSI) do/does not support Type II CSI and enhanced Type II CSI.

11. The method according to any one of Supplements 1 to 6, wherein the CSI reporting configuration and/or the CSI report and/or the first channel state information (CSI) and/or the second channel state information (CSI) support(s) a CQI with wideband granularity (wideband CQI) and/or a PMI with wideband granularity (wideband PMI).

12. The method according to Supplement 11, wherein the CSI reporting configuration and/or the CSI report and/or the first channel state information (CSI) and/or the second channel state information (CSI) do/does not support a CQI with subband granularity (subband CQI) and/or a PMI with subband granularity (subband PMI).

13. The method according to any one of Supplements 1 to 6, wherein the CSI reporting configuration and/or the CSI report support(s) aperiodic CSI report, or, a reporting type (reportConfigType) parameter in the CSI reporting configuration is configured as aperiodic.

14. The method according to Supplement 13, wherein the CSI reporting configuration and/or the CSI report do/does not support: PUCCH-based semi-persistent CSI report and PUSCH-based semi-persistent CSI report and periodic CSI report, or, the reporting type (reportConfigType) parameter in the CSI reporting configuration is not configured as: periodic or PUCCH semi-persistent (semiPersistentOnPUCCH) or PUSCH semi-persistent (semiPersistentOnPUSCH).

15. The method according to any one of Supplements 1 to 6, wherein the CSI reporting configuration and/or the CSI report support(s) aperiodic CSI report and PUSCH-based semi-persistent CSI report, or, the CSI reporting configuration and/or the CSI report support(s) PUSCH-based CSI report, or, a reporting type (reportConfigType) parameter in the CSI reporting configuration is configured as aperiodic or PUSCH semi-persistent (semiPersistentOnPUSCH).

16. The method according to Supplement 15, wherein the CSI reporting configuration and/or the CSI report do/does not support periodic CSI report and PUCCH-based semi-persistent CSI report, or, the CSI reporting configuration and/or the CSI report do/does not support PUCCH-based CSI report, or, a reporting type (reportConfigType) parameter in the CSI reporting configuration is not configured as periodic or PUCCH semi-persistent (semiPersistentOnPUCCH).

17. The method according to any one of Supplements 1 to 6, wherein the CSI reporting configuration and/or the CSI report support(s) aperiodic CSI report, PUSCH-based semi-persistent CSI report and PUCCH-based semi-persistent CSI report, or, the CSI reporting configuration and/or the CSI report support(s) aperiodic CSI report and semi-persistent CSI report, or, a reporting type (reportConfigType) parameter in the CSI reporting configuration is configured as aperiodic or semiPersistentOnPUSCH or semiPersistentOnPUCCH.

18. The method according to Supplement 17, wherein the CSI reporting configuration and/or the CSI report do/does not support periodic CSI report, or, a reporting type (reportConfigType) parameter in the CSI reporting configuration is not configured as periodic.

19. The method according to any one of Supplements 1 to 6, wherein a feedback quantity (reportQuantity) parameter in the channel state information (CSI) reporting configuration includes at least one of the following: first information (cri-RI-LI-PMI-CQI) indicating to feed back CRI, RI, LI, PMI and CQI, second information (cri-RI-PMI-CQI) indicating to feed back CRI, RI, PMI and CQI, third information (cri-RI-i1) indicating to feed back CRI, RI, i1, fourth information (cri-RI-i1-CQI) indicating to feed back CRI, RI, i1 and CQI, and fifth information (cri-RI-CQI) indicating to feed back CRI, RI and CQI.

20. The method according to any one of Supplements 1 to 19, wherein a codebook type (codebook Type) parameter in the channel state information (CSI) reporting configuration includes at least one of the following: a type I single panel (typeI-SinglePanel), a type I multi-panel (typeI-MultiPanel).

21. The method according to Supplement 20, wherein the channel state information (CSI) reporting configuration is associated with the first reference signal resource and the second reference signal resource, the codebook type (codebookType) is expected to be set as a first parameter, the first parameter being type I (typeI) and/or a type I single panel (typeI-SinglePanel) and/or a type I multi-panel (typeI-MultiPanel).

22. The method according to any one of Supplements 1 to 21, wherein a codebook configuration (codebookConfig) in the channel state information (CSI) reporting configuration is configured with a first codebook subset restriction and a second codebook subset restriction, the first codebook subset restriction being applicable to a reported PMI associated with the first reference signal resource, and the second codebook subset restriction being applicable to a reported PMI associated with the second reference signal resource.

23. The method according to any one of Supplements 1 to 21, wherein the codebook configuration (codebookConfig) in the channel state information (CSI) reporting configuration is configured with a codebook subset restriction, the codebook subset restriction being applicable to the reported PMI associated with the first reference signal resource, and a subset of the codebook subset restriction being applicable to the reported PMI associated with the second reference signal resource.

24. The method according to Supplement 22, wherein the codebook configuration (codebookConfig) in the channel state information (CSI) reporting configuration is configured with a first codebook subset restriction and a second codebook subset restriction, wherein the first reference signal resource corresponds to a first value of the first parameter of the codebook type, and the second reference signal resource corresponds to a second value of the first parameter of the codebook type.

25. The method according to any one of Supplements 1 to 24, wherein the channel state information (CSI) reporting configuration includes a second parameter, the second parameter being used to indicate at least one of the following:
whether the CSI report contains multiple pieces of CSI;
whether the CSI report is associated with multiple modes/patterns;
whether the CSI report is related to network energy saving; or
whether the CSI report is associated with a first reference signal resource and a second reference signal resource for channel measurement.

26. The method according to any one of Supplements 1 to 24, wherein the channel state information (CSI) reporting configuration includes a second parameter, the second parameter being used to indicate at least one of the following:
the number of CSI contained in the CSI report;
modes/patterns associated with the CSI report;
the number of modes/patterns associated with the CSI report;
a CSI feedback quantity associated with the CSI report;
the number of reference signal resources for channel measurement whether is associated with the CSI report; or
port indication information of the second reference signal resource when the second parameter signal resource is a part of the first reference signal resource.

27. The method according to any one of Supplements 1 to 26, wherein based on the second parameter, or based on the first reference signal resource and the second reference signal resource, the terminal equipment transmits a first CRI and a second CRI, or transmits the first CRI and does not transmit the second CRI, or transmits neither the first CRI nor the second CRI;
the first CRI and the second CRI are associated with the first reference signal resource and the second reference signal resource, respectively, or are associated with the first CSI and the second CSI, respectively.

28. The method according to any one of Supplements 1 to 26, wherein based on the second parameter, or based on the first reference signal resource and the second reference signal resource, the terminal equipment transmits a first RI and a second RI, or transmits the first RI;
the first RI and the second RI are associated with the first reference signal resource and the second reference signal resource, respectively, or are associated with the first CSI and the second CSI, respectively.

29. The method according to any one of Supplements 1 to 26, wherein based on the second parameter, or based on the first reference signal resource and the second reference signal resource, the terminal equipment transmits a first PMI and a second PMI, or transmits the first PMI;
a network device derives the second PMI based on the first PMI; the first PMI and the second PMI are associated with the first reference signal resource and the second reference signal resource, respectively, or are associated with the first CSI and the second CSI, respectively.

30. The method according to any one of Supplements 1 to 26, wherein based on the second parameter, or based on the first reference signal resource and the second reference signal resource, the terminal equipment transmits a first PMI and a first PMI offset;
the network device derives the second PMI based on the first PMI and the first PMI offset; the first PMI and the first PMI offset are associated with the first reference signal resource and the second reference signal resource, respectively, or are associated with the first CSI and the second CSI, respectively.

31. The method according to any one of Supplements 1 to 26, wherein based on the second parameter, or based on the first reference signal resource and the second reference signal resource, the terminal equipment transmits a first CQI and a second CQI, or transmits the first CQI;
a network device derives the second CQI based on the first CQI; the first CQI and the second CQI are associated with the first reference signal resource and the second reference signal resource, respectively, or are associated with the first CSI and the second CSI, respectively.

32. The method according to any one of Supplements 1 to 26, wherein based on the second parameter, or based on the first reference signal resource and the second reference signal resource, the terminal equipment transmits a first CQI and a first CQI offset;
the network device derives the second CQI based on the first CQI and the first CQI offset; the first CQI and the first CQI offset are associated with the first reference signal resource and the second reference signal resource, respectively, or are associated with the first CSI and the second CSI, respectively.

33. The method according to any one of Supplements 27 to 32, wherein in a case where LI is configured, based on the second parameter, or based on the first reference signal resource and the second reference signal resource, the terminal equipment transmits a first L1 and a second LI, or transmits the first L1 and does not transmit the second L1, or transmits neither the first LI nor the second LI.

34. The method according to any one of Supplements 1 to 33, wherein the CSI report includes N pieces of CSI, the CSI reporting configuration is at least associated with N reference signal resources for channel measurement, the N pieces of CSI are associated with the N reference signal resources respectively, where N is greater than or equal to 2.

35. The method according to Supplement 34, wherein the method further includes:
the terminal equipment selects/decides/determines that the CSI report contains K pieces of CSI, the K pieces of CSI at least including the first CSI and the second CSI, where K is greater than or equal to 2 and K is less than or equal to N.

36. The method according to Supplement 35, wherein the first CSI in the K pieces of CSI, and a third parameter are included in a first part (CSI Part I) in the CSI report, the remaining (K−1) pieces of CSI are included in a second part (CSI Part II) in the CSI report, and the third parameter is used to indicate a feedback quantity of and/or a bit size of the (K−1) pieces of CSI in the second part (CSI Part II).

37. The method according to Supplement 36, wherein the third parameter indicates whether the (K−1) pieces of CSI in the second part (CSI Part II) contain the CRI and/or the RI and/or the PMI and/or the PMI offset and/or the CQI and/or the CQI offset.

38. A method for transmitting channel state information (CSI) report, including:
a terminal equipment receives a channel state information (CSI) reporting configuration; and
transmits a CSI report according to the channel state information (CSI) reporting configuration;
wherein the CSI reporting configuration is at least associated with N reference signal resources for channel measurement, and/or, the CSI report includes N pieces of channel state information (CSI), the N pieces of CSI being associated with the N reference signal resources respectively.

39. The method according to Supplement 38, wherein the method further includes:
the terminal equipment selects/decides/determines that the CSI report contains K pieces of CSI, where K is greater than or equal to 1 and K is less than or equal to N.

40. The method according to Supplement 39, wherein the first CSI in the K pieces of CSI, and a third parameter are included in a first part (CSI Part I) in the CSI report, the remaining (K−1) pieces of CSI are included in a second part (CSI Part II) in the CSI report, and the third parameter is used to indicate a feedback quantity of and/or a bit size of the (K−1) pieces of CSI in the second part (CSI Part II).

41. The method according to Supplement 40, wherein the third parameter indicates whether the (K−1) pieces of CSI in the second part (CSI Part II) contain the CRI and/or the RI and/or the PMI and/or the PMI offset and/or the CQI and/or the CQI offset.

42. A method for receiving channel state information (CSI) report, including:
a network device transmits a channel state information (CSI) reporting configuration; and
the network device receives a CSI report transmitted by a terminal equipment according to the channel state information (CSI) reporting configuration;
wherein the CSI reporting configuration is at least associated with a first reference signal resource and a second reference signal resource for channel measurement, and/or, the CSI report at least includes first channel state information (CSI) and second channel state information (CSI), the first channel state information (CSI) being associated with the first reference signal resource for channel measurement, and the second channel state information (CSI) being associated with the second reference signal resource for channel measurement.

43. A terminal equipment, including a memory and a processor, the memory storing a computer program, and the processor being configured to execute the computer program to implement the method for transmitting channel state information report according to any one of Supplements 1 to 41.

44. A network device, including a memory and a processor, the memory storing a computer program, and the processor being configured to execute the method for receiving channel state information report according to Supplement 42.

1. An apparatus for transmitting channel state information report, configured in a terminal equipment, the apparatus comprising:
a receiver configured to receive a channel state information reporting configuration, wherein M reference signal resources being associated with the channel state information reporting configuration, the channel state information reporting configuration at least including port information and/or power information and/or codebook information of one of the M reference signal resources;
a transmitter configured to transmit a channel state information report according to the channel state information reporting configuration; and
wherein the channel state information report at least includes M pieces of channel state information, one of the M pieces of channel state information being associated with one of the M reference signal resources; wherein the port information is for antenna ports or reference signal ports, and the code book information is a codebook type parameter being expected to be set to type 1.

2. The apparatus according to claim 1, wherein M is equal to or more than 2.

3. The apparatus according to claim 1, wherein the power information is reference signal power offset and/or PDSCH power offset.

4. The apparatus according to claim 1, wherein the terminal equipment expects to be configured with the codebook type parameter, the codebook type parameter being set to type 1 only.

5. The apparatus according to claim 4, wherein the codebook type parameter is set to typeI-SinglePanel or typeI-MultiPanel.

6. The apparatus according to claim 1, wherein a report quantity of a first channel state information is same as a report quantity of a second channel state information.

7. The apparatus according to claim 1, wherein a first reference signal resource or a second reference signal resource is at least one of the following: at least one channel state information resource configuration, at least one non-zero power channel state information reference signal resource set, or at least one non-zero power channel state information reference signal resource.

8. An apparatus for receiving channel state information report, configured in a network device, the apparatus comprising:
a transmitter configured to transmit a channel state information reporting configuration, wherein M reference signal resources being associated with the channel state information reporting configuration, the channel state information reporting configuration at least including port information and/or power information and/or codebook information of one of the M reference signal resources;
a receiver configured to receive a channel state information report transmitted by a terminal equipment according to the channel state information reporting configuration; and
wherein the channel state information report at least includes M pieces of channel state information, one of the M pieces of channel state information being associated with one of the M reference signal resources; wherein the port information is for antenna ports or reference signal ports, and the code book information is a codebook type parameter being expected to be set to type 1.

9. The apparatus according to claim 8, wherein M is equal to or more than 2.

10. The apparatus according to claim 8, wherein the power information is reference signal power offset and/or PDSCH power offset.

11. The apparatus according to claim 8, wherein the terminal equipment expects to be configured with the codebook type parameter, the codebook type parameter being set to type 1 only.

12. The apparatus according to claim 11, wherein the codebook type parameter is set to typeI-SinglePanel or typeI-MultiPanel.

13. The apparatus according to claim 8, wherein a report quantity of a first channel state information is same as a report quantity of a second channel state information.

14. The apparatus according to claim 8, wherein a first reference signal resource or a second reference signal resource is at least one of the following: at least one channel state information resource configuration, at least one non-zero power channel state information reference signal resource set, or at least one non-zero power channel state information reference signal resource.

15. A communication system, comprising:
a network device, configured to transmit a channel state information reporting configuration and receive a channel state information report, wherein M reference signal resources being associated with the channel state information reporting configuration, the channel state information reporting configuration at least including port information and/or power information and/or codebook information of one of the M reference signal resources;
a terminal equipment, configured to transmit the channel state information report according to the channel state information reporting configuration; and
wherein the channel state information report at least includes M pieces of channel state information, one of the M pieces of channel state information being associated with one of the M reference signal resources; wherein the port information is for antenna ports or reference signal ports, and the code book information is a codebook type parameter being expected to be set to type 1.
